(19) United States
(12) Patent Application Publication
(10) Pub. No.: US 2009/0043875 A1
(43) Pub. Date: Feb. 12, 2009

(54) COMMUNICATION APPARATUS AND NETWORK CONNECTION MANAGEMENT PROGRAM

(75) Inventor: Takeshi TAJIMA, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/186,089

(22) Filed: Aug. 5, 2008

(30) Foreign Application Priority Data
Aug. 6, 2007 (JP) 2007-204349

(51) Int. Cl. G06F 15/173

(52) U.S. Cl. 709/223

(57) ABSTRACT

According to one embodiment, a communication apparatus performing communication via a network by using a communication section has the following units. In other words, the communication apparatus includes: a port closing unit performing port closing in which every port except a port necessary for obtaining an address of an external apparatus to be a counterpart of the communication via the network is closed; an address obtaining unit obtaining the address of the external apparatus by using the port necessary for obtaining the address of the external apparatus; a judging unit judging properness/improperness of the network by using the address obtained by the address obtaining unit, after the port closing unit performs the port closing; and a network connection managing unit controlling to open the port used for connection to the network judged to be proper by the judging unit and to cut off connection to the network judge to be improper by the judging unit.

### CROSS-REFERENCE TO RELATED APPLICATIONS

This application is based upon and claims the benefit of priority from Japanese Patent Application No. 2007-204349, filed Aug. 6, 2007, the entire contents of which are incorporated herein by reference.

### BACKGROUND

1. Field

One embodiment of the invention relates to a communication apparatus, such as a personal computer, performing communication via a network by using a communication section, and to a network connection management program.

2. Description of the Related Art

In recent years, as data communication using the Internet becomes widespread, there are increased occasions where a communication apparatus such as a personal computer is connected to various networks. Accordingly, a possibility is quite high that a communication apparatus connected to the network is attacked by a computer virus or subjected to unauthorized access from the outside.

Under such circumstances, conventionally, there is disclosed, for example, in Japanese Patent Application Publication (KOKAI) No. 2005-321897 (Patent Document 1), a data communication processing program product for performing data communication in a state that only a port for receiving a response to a search request for a latest version of predetermined data is opened to reduce a risk of receiving unintended data.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a network connection management system having a computer as a communication apparatus according to an embodiment of the invention and a server apparatus;

FIG. 2 is an exemplary block diagram showing an internal configuration of the computer shown in FIG. 1 in the embodiment;

FIG. 3 is an exemplary block diagram showing a relationship between a program managed by an OS and a plurality of communication devices in the embodiment;

FIG. 4 is an exemplary flowchart showing an operation procedure of network connection management in the embodiment; and

FIG. 5 is an exemplary diagram showing an example of a network list in the embodiment.

### DETAILED DESCRIPTION

Various embodiments according to the invention will be described hereinafter with reference to the accompanying drawings. In general, according to one embodiment of the invention, a communication apparatus performing communication via a network by using a communication section has the following units. In other words, the communication apparatus includes: a port closing unit performing port closing in which every port except a port necessary for obtaining an address of an external apparatus to be a counterpart of the communication via the network is closed; an address obtaining unit obtaining the address of the external apparatus by using the port necessary for obtaining the address of the external apparatus; a judging unit judging properness/improperness of the network by using the address obtained by the address obtaining unit, after the port closing unit performs the port closing; and a network connection managing unit controlling to open the port used for connection to the network judged to be proper by the judging unit and to cut off connection to the network judge to be improper by the judging unit.

A network connection management program product applied to a communication apparatus performing communication via a network by using a communication section has the following functions. In other words, the network connection management program product includes a computer program causing a computer to realize functions including: a port closing function performing port closing in which every port except a port necessary for obtaining an address of an external apparatus to be a counterpart of communication via the network is closed; an address obtaining function obtaining the address of the external apparatus by using the port necessary for obtaining the address of the external apparatus; a judging function judging properness/improperness of the network by using the address obtained by the address obtaining function, after the port closing is performed by the port closing function; and a network connection management function controlling to open a port used for connection to the network judged to be proper by the judging function, and to cut off connection to the network judged to be improper by the judging function.

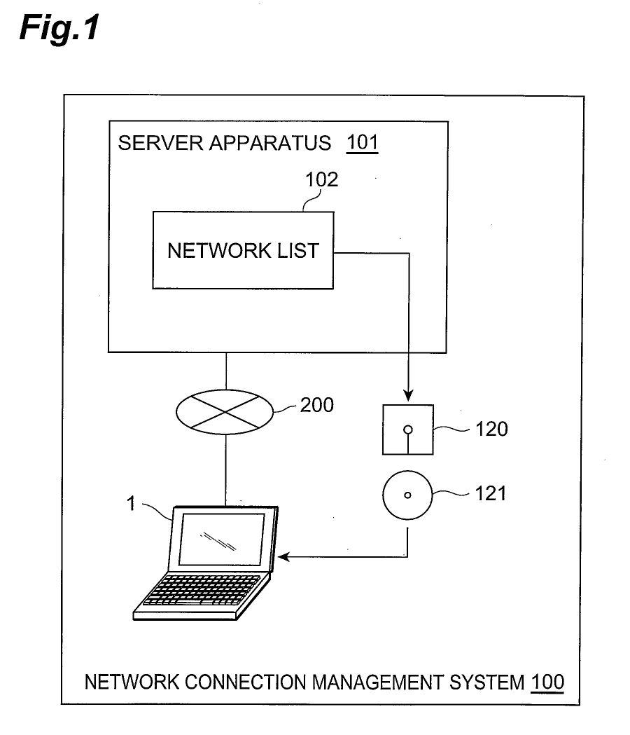

FIG. 1 is a block diagram showing a configuration of a network connection management system 100 having a personal computer (hereinafter, referred to as “computer”) 1 as a communication apparatus according to an embodiment of the invention and a server apparatus 101.

In a network connection management system 100, when communication via a network is performed, the computer 1 judges properness/improperness of the network in advance by using a later-described network list 102 provided by the sever apparatus 101. The computer 1 suspends connection to that network until the network is confirmed to be safe and prohibits connection to an unsafe network, whereby the computer 1 performs dynamic management of network connection.

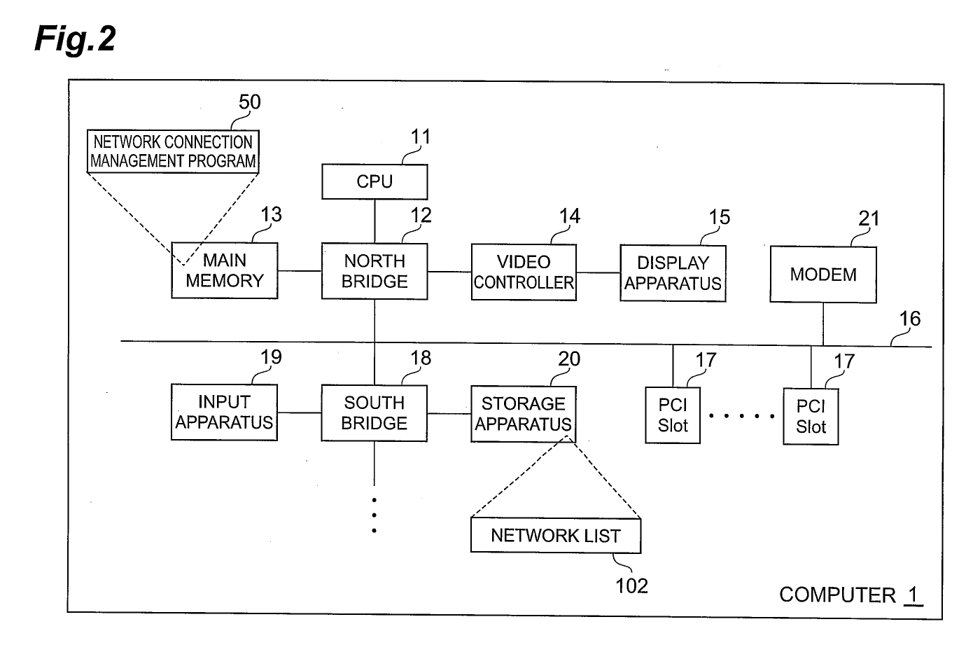

Next, the computer 1 will be described with reference to FIG. 2. FIG. 2 is a block diagram showing an internal configuration of the computer 1. Though the computer 1 in the embodiment is supposed to be, for example, a portable notebook type personal computer, the invention is not limited to the notebook type personal computer.

The computer 1 has, as shown in FIG. 2, a CPU 11, a north bridge 12, a main memory 13, a video controller 14, and a display apparatus 15. Further, the computer 1 has a PCI (Peripheral Component Interconnect) bus 16, a PCI slot 17, a south bridge 18, an input apparatus 19, a storage apparatus 20, and a modem 21.

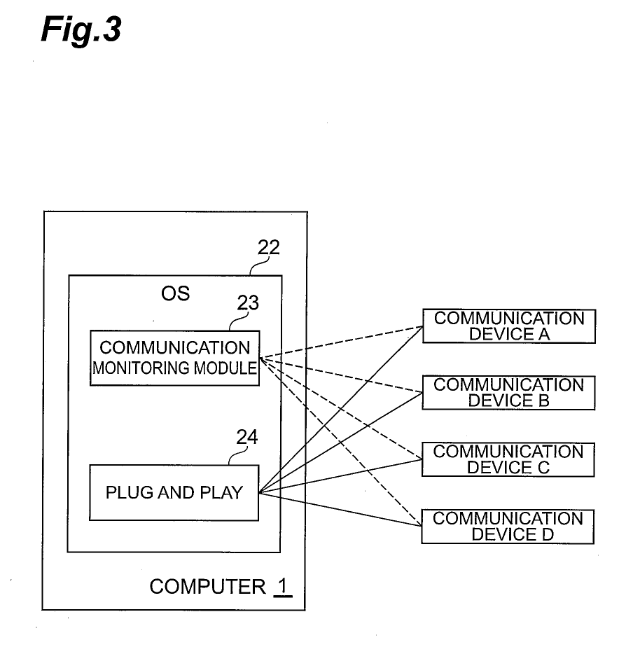

The CPU 11 is a processor to control the entire computer 1. The CPU 11 executes a software program managed by an operating system (OS) 22 (see FIG. 3) working on the main memory 13, and controls communication performed by a plurality of communication sections (later-described communication devices A, B, C, D) mounted to a plurality of PCI bus slots 17 or the modem 21 with a not-shown external computer (an external apparatus).

The north bridge 12 is connected to the CPU 11, the main memory 13 and the video controller 14, and controls data flowing between the CPU 11 and the main memory 13 as well as the video controller 14. The north bridge 12 has various controllers to perform a bridge processing between the CPU 11 and the south bridge 18, control of the main memory 13, control of the video controller 14 and the like.

The main memory 13 holds the OS 22 processed by the CPU 11, various application programs, various drivers, a later-described network connection management program 50 and the like, and is provided as a work area of the CPU 11.

The video controller 14 is connected to the north bridge 12 via an AGP (Accelerated Graphics Port), and performs control of image display in the display apparatus 15.

The display apparatus 15 has an LCD (Liquid crystal Display) and displays an image on the LCD by using a display signal transmitted from the video controller 14.

The PCI bus 16 is a bus located between the north bridge 12 and the south bridge 18, and the plural PCI bus slots 17 are connected thereto.

The PCI bus slot 17 is an expansion slot (a connector) provided on the PCI bus 16, and it is possible to mount a PCI compatible communication section (for example, a device to realize various communication functions such as a wireless LAN card and a wired LAN card, and in the embodiment, the later-described communication devices A, B, C, D) from the outside.

The south bridge 18 has a PCI-ISA bridge to perform communication between the PCI bus 16 and an ISA (Industry Component Interconnect) bus (not shown), and also has a USB (Universal Serial Bus) controller to control a USB-compatible apparatus, an IDE (Integrated Device Electronics) controller to control various disc drives, or the like.

The input apparatus 19 is equivalent to a mouse or a keyboard enabling an input operation by a user, and is realized as, for example, a USB-compatible apparatus.

The storage apparatus 20 is equivalent to a hard disc drive or a CD-ROM drive to hold a program or data, and is realized as, for example, an IDE compatible apparatus. This storage apparatus 20 stores the network list 102 provided from the server apparatus 101.

The modem 21 is connected to the PCI bus 16 via a not-shown I/O hub or the like, and performs a modulation processing from a digital signal to an analog signal and a demodulation processing from the analog signal to the digital signal. It should be noted that the analog signal converted from the digital signal by the modem 21 is transmitted to an external computer via a not-shown telephone line.

In the embodiment, the case is supposed that four communication sections are mounted to the plural PCI slots 17, and as shown in FIG. 3, these four communication sections are indicated as the communication devices A to D.

Next, FIG. 3 is a block diagram showing a relationship between the program managed by the OS 22 working on the main memory 13 and the plurality of the communication sections (communication devices A to D).

The OS 22 has various functions (software) such as a communication monitoring module 23 and a plug and play function (PnP) 24, and dynamically manages such functions.

The communication monitoring module 23 constantly monitors respective communication sates of the communication devices A to D.

The plug and play function (PnP) 24 is a function supported by, for example, the OS 22 in advance and a function to dynamically perform automatic setting related to addition/deletion (here, addition/deletion of the communication devices A to D) of hardware without stopping the function of the OS 22. In the embodiment, the PnP 24 is at least capable of performing connection control to the PCI compatible device.

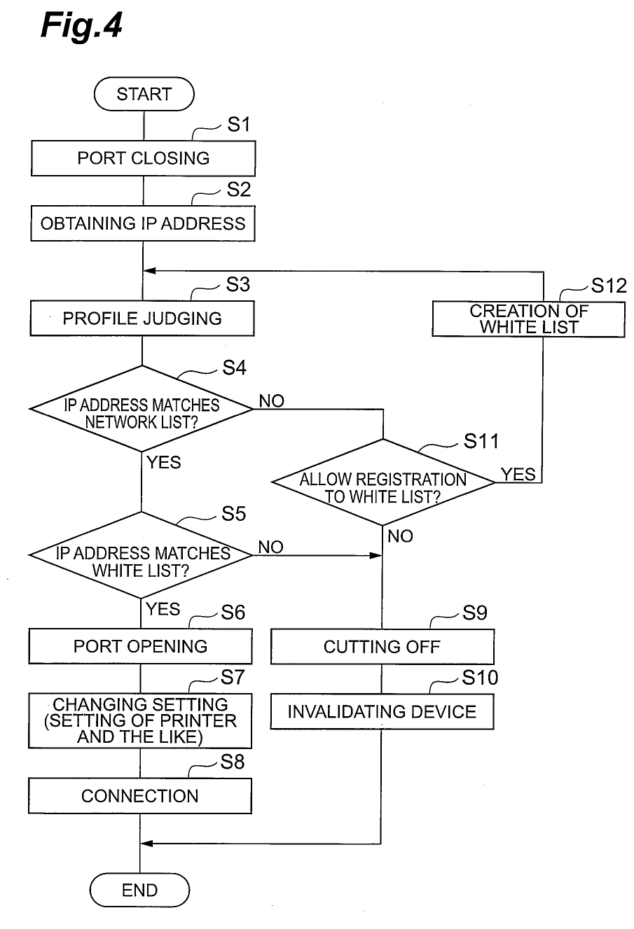

Next, an operation content of network connection management by the network connection management program 50 will be described with reference to FIG. 4. FIG. 4 is a flowchart showing an operation procedure of the network connection management by the network connection management program 50. The network connection management program 50 is executed by the CPU 11.

When the CPU 11 starts executing the network connection management program 50, the CPU 11 performs an operation as a port closing unit and performs port closing (S1). S1 is performed, for the purpose of examining whether a network (hereinafter, referred to “target network”) to be connected to is a safe network to connect, to stop other functions than a function to obtain an IP address of an external apparatus to be a counterpart of communication via the network. By performing S1, only the port (address obtaining port) necessary for obtaining the IP address of the external apparatus is opened and all the other ports are closed.

Next, proceeding to S2, the CPU 11 performs an operation as an address obtaining unit and obtains the IP address of the external apparatus to be the counterpart of communication via the target network by using the address obtaining port. In order to examine what the target network is like, at least the IP address of the external apparatus such as a computer connected to the target network is necessary, and that IP address is obtained in S2.

Next, proceeding to S3, the CPU 11 performs profile judgment. This profile judgment is performed to examine what the target network is like. In S3, the CPU 11 performs an operation as a collating unit and collates the IP address obtained in S2 with the network list 102. In the network list 102 are registered networks (hereinafter, referred to as “networks to be connected”) to which the computer 1 is to be connected, with the network allowable to be connected and the network not allowable to be connected being separated, so that the network list 102 indicates properness/improperness (whether or not proper to connection) of a plurality of the networks to be connected, details being described later.

Then, the CPU 11 progresses to S4 and judges whether or not the IP address obtained in S2 matches the network list 102 (whether or not registered in the network list 102) based on a collating result in S3. If the CPU 11 judges that the IP address matches the network list 102, the CPU 11 progresses to S5, and otherwise, the CPU 11 progresses to S11.

When progressing to S5, the CPU 11 performs an operation as a judging unit, and judges properness/improperness of the target network based on the collating result in S3. In this case, the CPU 11 judges whether or not the IP address obtained in S2 matches a later-described white list 110. If the CPU 11 judges that the IP address matches the white list 110, the CPU 11 regards the IP address as proper and progresses to S6, while otherwise the CPU 11 regards the IP address as improper and progresses to S9.

When progressing to S6, the CPU 11 performs an operation as a network connection management unit and performs port opening. This port opening is performed in order to realize various services such as downloading of image data and viewing of a WEB page by opening a port used for connection with the target network to perform communication with the external apparatus via the target network.

Further, in subsequent S7, the CPU 11 performs alteration of various settings (for example, a setting of a printer) to perform communication via the target network, and proceeds to S8 to make connection to the target network.

As stated above, by the computer 1, communication with the external computer via the target network is performed by using, for example, any one of the communication devices A to D or the modem 21.

On the other hand, when proceeding to S9, the CPU 11 performs the operation as the network connection management unit and controls to cut off connection to the target network.

In subsequent S10, the CPU 11 performs an operation as an invalidating unit. In this case, since the IP address does not match the white list 110 despite the fact that the IP address is registered in the network list 102, the CPU 11 regards the target network as a prohibited network, to which connection is prohibited, and invalidates an operation of the communication device performing communication via that prohibited network.

Further, proceeding from S4 to S11, the CPU 11 performs an operation as a registration allowability judging unit and performs new registration judgment of the IP address. In S1, since the IP address obtained in S2 is unregistered in the network list 102 (the target network is a network out of a scope of a management target until then), the CPU 11 newly creates a later-described profile using that IP address and judges whether or not registration to the white list 110 is allowable (a standard of judgment in S11 differs depending on a policy of network connection management).

Then, if the CPU 11 judges that the registration to the white list 110 is allowable, the CPU 11 proceeds to S12 to perform an operation as a setting information creating unit and newly creates the profile using the IP address. Thereafter, the CPU 11 registers the newly created profile to the white list 110, and then returns to S3 to repeat the operations described above. If the CPU 11 judges not to register, the CPU 11 proceeds to S9 and repeats the operations described above.

The network list 102 is provided from the server apparatus 101 and held in the computer 1. For example, as shown in FIG. 1, the network list 102 is stored in a removable medium such as a flexible disc 120 and an optical disc 121 in the server apparatus 101, and a reading, operation from the removable medium is performed by the computer 1 so that the network list 102 is held. As shown in FIG. 1, the computer 1 may perform downloading from the server apparatus 101 via the Internet 200 to hold the network list 102. However, considering security, using the removal medium is preferable.

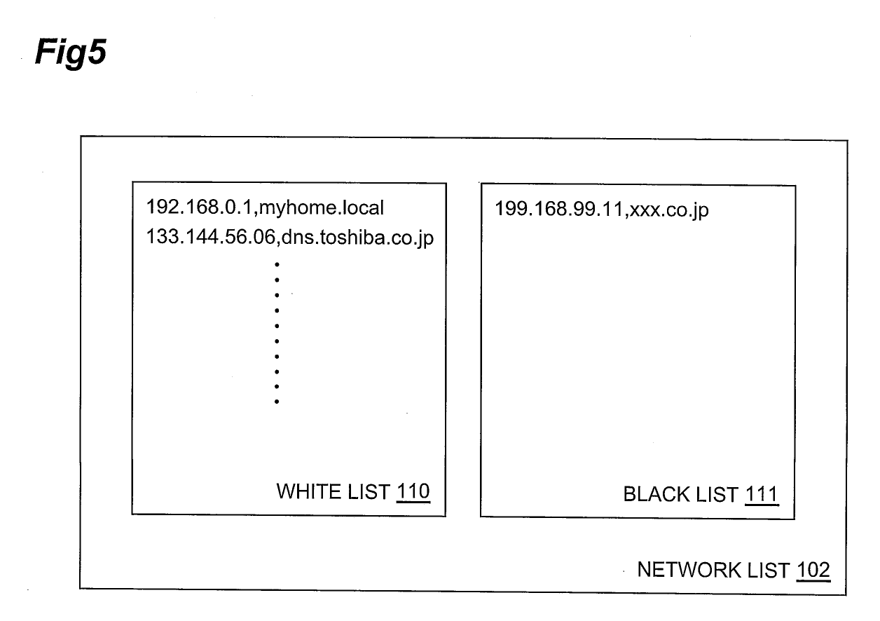

In the embodiment, registration in the network list 102 is divided into registration in the white list 110 and registration in a black list 111, as shown in FIG. 5.

In the white list 110 is registered a profile of a network (allowed network) which is safe and allowed to be connected, that is, proper for connection (with properness), while in the black list 111 is registered a profile of a network (prohibited network) which is prohibited to be connected, that is, improper for connection (without properness).

The profile is various kinds of setting information used for connection to the network, for example, information related to an IP address, a home page address, setting of valid/invalid state of a communication device, setting of a DHCP (Dynamic Host Configuration Protocol), setting of a DNS server (Domain Name Server) and so on.

It should be noted that, in FIG. 5, IP addresses (for example, “192.168.0.1”) and the DNS server (for example, “dns.sw.toshiba.co.jp”) among the above are shown.

As stated above, the computer 1 obtains the IP address after performing port closing, confirming whether or not the target network is safe by using the obtained IP address, and, after confirming that the target network is safe, opens the port to perform communication. In other words, the computer 1 sustains connection to the target network until it is confirmed that the target network is safe.

When the computer 1 performs connection to the network, since the computer 1 closes and opens the port as above to dynamically manage opening/closing of the port, there is no possibility of being connected to an unsafe network, so that a security level is able to be improved.

Therefore, in the computer 1, when the user tries to connect to a network which is not allowed by a manager, it is possible to surely prohibit the connection to that network.

Further, for example, by performing a processing of transmitting a notification message to a computer (not shown) used by the manager from the computer 1 during S5 to S9 or during S9 to s10, a fact that the connection to the network that the manger does not intend (in the above embodiment, the network registered in the blacklist 111) is tried to be made can be notified to the manager, and it becomes possible that the user of the computer 1 requests permission of connection from the manager.

Further, by distributing the network list 102 to the computer 1, the manger can notify the user which network is safe and accessible and perform access control to the network uniformly.

It should be noted that the embodiment can be implemented by using various kinds of OS's, such as Windows (registered trademark), Linux/FreeBSD, and Mac OS.

Further, though the example is explained in which the external communication devices A, B, C, D are used as the communication section, a built-in communication device (not shown) can be used instead of the external communication devices A, B, C, D.

The above description is for explaining the embodiment of the invention and does not limit the apparatus and the method of the invention, and various modification examples thereof can be implemented easily. Further, an apparatus or a method formed by appropriately combining the components, functions, features or method steps in each embodiment is also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus performing communication via a network by using a communication section, comprising:
a port closing unit performing port closing in which every port except a port necessary for obtaining an address of an external apparatus to be a counterpart of the communication via the network is closed;
an address obtaining unit obtaining the address of the external apparatus by using the port necessary for obtaining the address of the external apparatus;
a judging unit judging properness/improperness of the network by using the address obtained by said address obtaining unit, after said port closing unit performs the port closing; and
a network connection managing unit controlling to open the port used for connection to the network judged to be proper by said judging unit and to cut off connection to the network judge to be improper by said judging unit.

2. The communication apparatus according to claim 1, further comprising
a collating unit collating the address obtained by said address obtaining unit with a network list indicating properness/improperness of a network to be connected, which is expected to be connected, wherein
said judging unit judges properness/improperness of the network based on a collation result of said collating unit.

3. The communication apparatus according to claim 2, wherein
registration in the network list is divided into registration of setting information including an allowed address used for connection to an allowed network which is allowed to be connected and registration of setting information including a prohibited address used for connection to a prohibited network which is prohibited from being connected.

4. The communication apparatus according to claim 1, further comprising
an invalidating unit invalidating an operation of the communication section performing communication via the network which is judged to be improper by said judging unit.

5. The communication apparatus according to claim 3, further comprising:
a registration allowability judging unit judging whether or not to allow the setting information including the address to be registered to the network list, when the collation result indicates that the setting information including the address obtained by said address obtaining unit is not registered in the network list; and
a setting information creating unit creating the setting information including the address, when said registration allowability judging unit judges to allow registration.

6. A network connection management program product applied to a communication apparatus performing communication via a network by using a communication section, the network connection management program product including a computer program causing a computer to realize functions comprising:
a port closing function performing port closing in which every port except a port necessary for obtaining an address of an external apparatus to be a counterpart of communication via the network is closed;
an address obtaining function obtaining the address of the external apparatus by using the port necessary for obtaining the address of the external apparatus;
a judging function judging properness/improperness of the network by using the address obtained by said address obtaining function, after the port closing is performed by said port closing function; and
a network connection management function controlling to open the port used for connection to the network judged to be proper by said judging function, and to cut off connection to the network judged to be improper by said judging function.
